(19) United States
(12) Patent Application Publication
(10) Pub. No.: US 2011/0235811 A1
(43) Pub. Date: Sep. 29, 2011

(54) MUSIC TRACK EXTRACTION DEVICE AND MUSIC TRACK RECORDING DEVICE

(75) Inventors: Tatsuo KOGA, Daito City (JP); Hisatoshi OOMAE, Nishinomiya City (JP); Hideto SHIMAOKA, Uji City (JP); Yuji YAMAMOTO, Yahata City (JP); Satoru MATSUMOTO, Kasai City (JP)

(73) Assignee: SANYO ELECTRIC CO., LTD., Osaka (JP)

(21) Appl. No.: 12/892,311

(22) Filed: Sep. 28, 2010

(30) Foreign Application Priority Data
Sep. 28, 2009 (JP) 2009-223066
Sep. 1, 2010 (JP) 2010-195431

(51) Int. Cl. H04R 29/00

(52) U.S. Cl. 381/56

(57) ABSTRACT

Provided is a music track extraction device, including: an audio power calculation section which calculates an audio power from an audio signal; and a judgment section which performs a judgment between a music track portion and a non-music track portion based on a state of the audio power.

This application is based on Japanese Patent Application No. 2009-223066 filed on Sep. 28, 2009 and Japanese Patent Application No. 2010-195431 filed on Sep. 1, 2010, the contents of which are hereby incorporated by reference.

### BACKGROUND OF THE INVENTION

1. Field of the Invention

The present invention relates to a music track extraction device which extracts only a music track portion from a radio broadcast program and a music track recording device which records a music track.

2. Description of Related Art

There is a digital reproduction device which automatically extracts a music portion from a received radio broadcast program and storing the music portion. For example, there is a digital reproduction device that extracts a music track portion by performing a judgment between stereo data and monaural data from left channel data and right channel data of broadcast data and setting a stereo portion as a music track and a monaural portion as a non-music track.

However, the digital reproduction device has a problem in that the degree of separation between the left and right channel data is small if received field intensity of a radio broadcast is low, and hence an audio signal being originally the stereo portion may be judged as a monaural signal, which makes it impossible to correctly extract a music track portion. The digital reproduction device has another problem of failing to extract a music track portion without a broadcast which transmits at least left and right channel data (for example, frequency modulation (FM) broadcast). Specifically, for example, a music track portion cannot be extracted from an amplitude modulation (AM) broadcast which transmits only monaural data.

### SUMMARY OF THE INVENTION

A music track extraction device according to the present invention includes:

an audio power calculation section which calculates an audio power from an audio signal; and

a judgment section which performs a judgment between a music track portion and a non-music track portion based on a state of the audio power.

A music track recording device according to the present invention includes:

the music track extraction device described above; and

a recording section which records an audio signal within a segment judged as a music track by the music track extraction device.

### BRIEF DESCRIPTION OF THE DRAWINGS

FIG. 1 is a hardware configuration diagram of a recording/reproduction device (100) according to a first embodiment;

FIG. 2 is a flowchart of a recording processing performed by the recording/reproduction device (100) according to the first embodiment;

FIG. 3 is a visual concept of an audio signal waveform, an audio power, and a change amount of the audio power;

FIG. 4 is a visual concept of an L-R difference;

FIG. 5 is a diagram illustrating an L-R difference signal in cases where field intensity is high and where the field intensity is low along with an audio power;

FIG. 6 is a flowchart of a playlist (music track position information) generation performed by the recording/reproduction device (100) according to the first embodiment;

FIG. 7 is a flowchart of reproduction performed by the recording/reproduction device (100) according to the first embodiment;

FIG. 8 is a hardware configuration diagram of a recording/reproduction device (100a) according to a second embodiment;

FIG. 9 is a functional block diagram of a main portion of the recording/reproduction device (100a) according to the second embodiment;

FIG. 10 is a visual concept of the audio signal waveform and a frequency of a second change point;

FIG. 11 is a flowchart of a recording processing performed by the recording/reproduction device (100a) according to the second embodiment;

FIG. 12 is a visual concept of a first time and a second time; and

FIG. 13 is a functional block diagram of a main portion of the recording/reproduction device (100a) according to another example of the second embodiment.

### DETAILED DESCRIPTION OF PREFERRED EMBODIMENTS

The meaning and effects of the present invention become clearer from the following description of embodiments. However, the following embodiments are mere examples of the embodiment of the present invention, and the meaning of the present invention or the meanings of the terms of respective components thereof are not limited to what are described in the following embodiments.

### First Embodiment

First, a recording/reproduction device 100 according to a first embodiment being an embodiment of the present invention is described in detail with reference to the drawings.

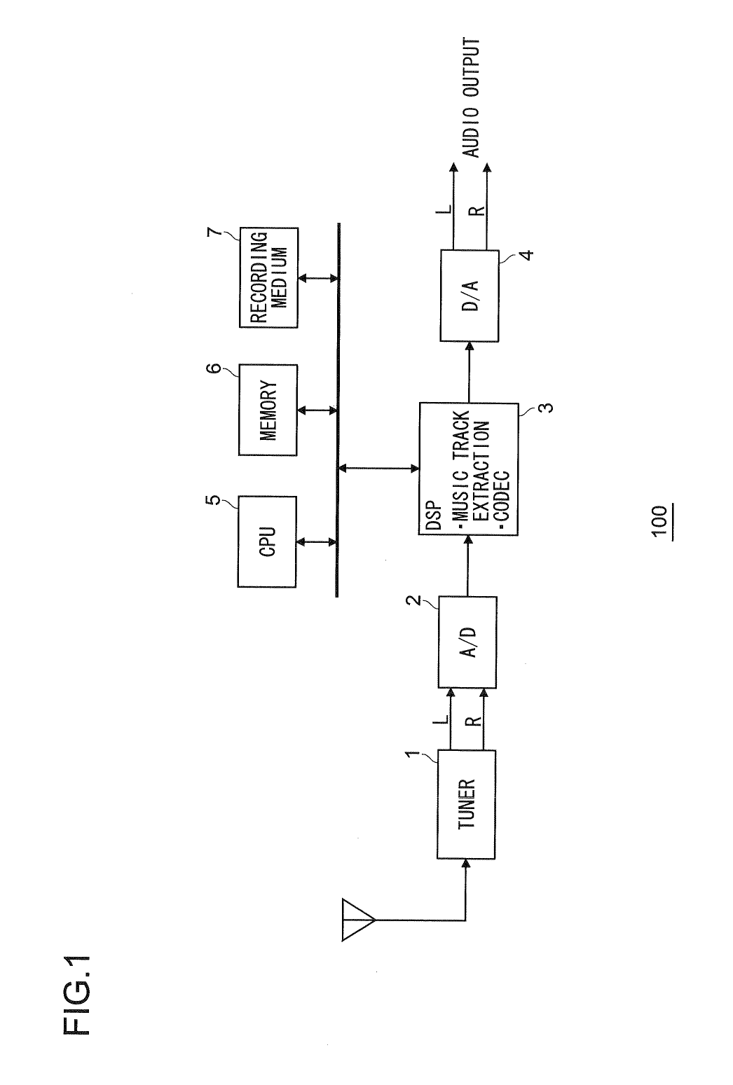

FIG. 1 is a hardware configuration diagram of the recording/reproduction device 100 according to the first embodiment being an embodiment of the present invention. The recording/reproduction device 100 according to this embodiment includes a frequency modulation (FM) tuner 1, an analog/digital (A/D) conversion section 2, a digital signal processor (DSP) 3, a digital/analog (D/A) conversion section 4, a central processing unit (CPU) 5, a memory 6, and a recording medium 7.

The FM tuner 1 demodulates an FM broadcast wave and outputs an analog audio signal. The A/D conversion section 2 converts the analog audio signal into a digital audio signal. The DSP 3 includes a music track extraction section (section which extracts only a music track portion from the audio signal and outputting the music track portion) and an audio codec section (including an encoder which encodes an uncompressed digital audio signal into compressed audio data and a decoder which decodes the compressed audio data into the uncompressed digital audio signal). The D/A conversion section 4 converts the digital audio signal into an analog audio signal and outputs the analog audio signal. If the audio signal is a stereo signal, respective signals of two left and right channels are output. The CPU 5 is a processor. The memory 6 is a so-called work memory for the CPU 5. Recorded on the recording medium 7 are the compressed audio data (recorded music track data) and setting information added thereto.

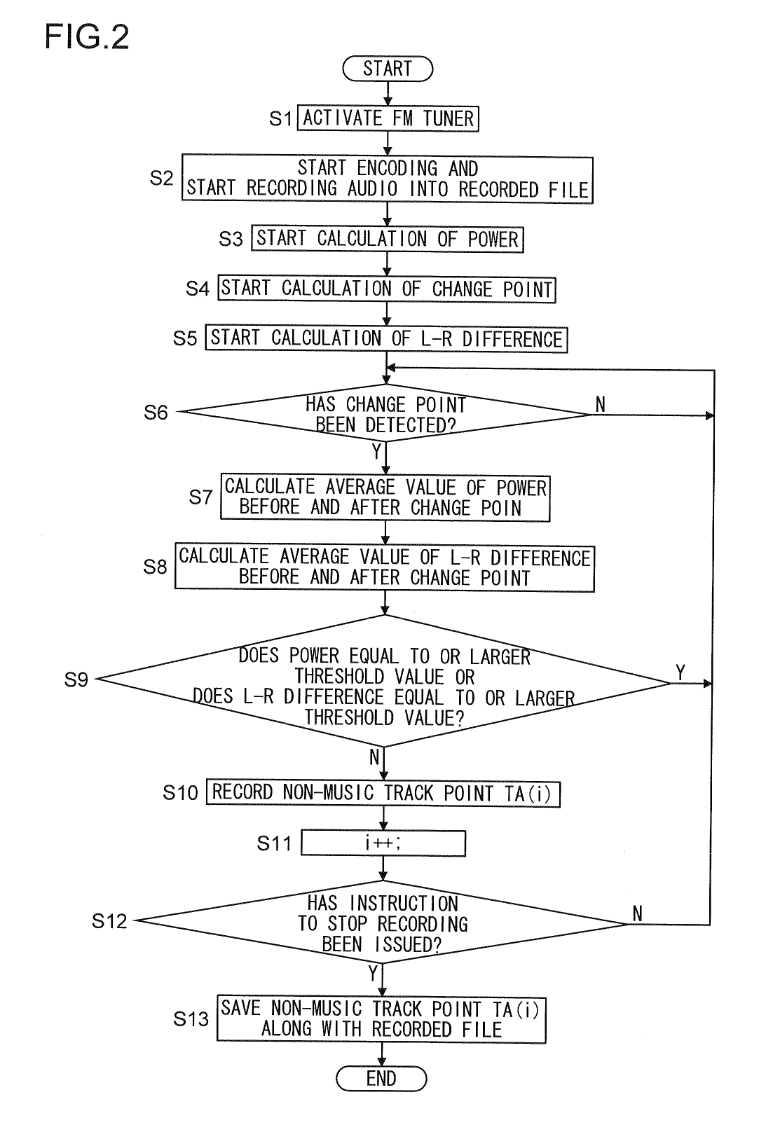

FIG. 2 is a flowchart of a recording processing performed by the recording/reproduction device 100 according to the first embodiment.

First, the FM tuner 1 and the encoder within the DSP 3 are activated, and an audio signal is recorded into a recorded file on the recording medium 7 (for example, HDD) while being encoded (S1 and S2). Based on an encoded sound waveform, calculation of an audio power value, calculation of a change amount of the audio power value, and calculation of a difference (L-R difference) signal between the two left and right channels are started (S3, S4, and S5).

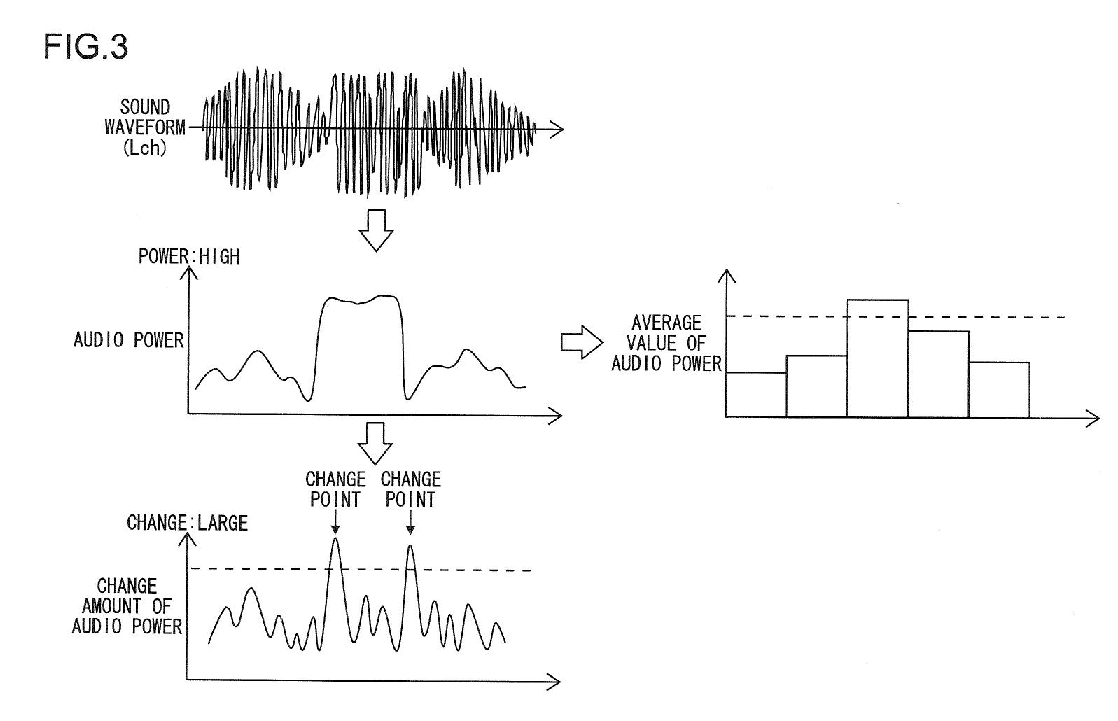

Here, FIG. 3 illustrates a visual concept of an audio signal waveform, an audio power, and the change amount of the audio power. The graph at the left top illustrates one channel (for example, Lch) of the audio signal. The graph at the left middle illustrates the audio power calculated based on the audio signal. The graph at the left bottom illustrates the change amount of the audio power.

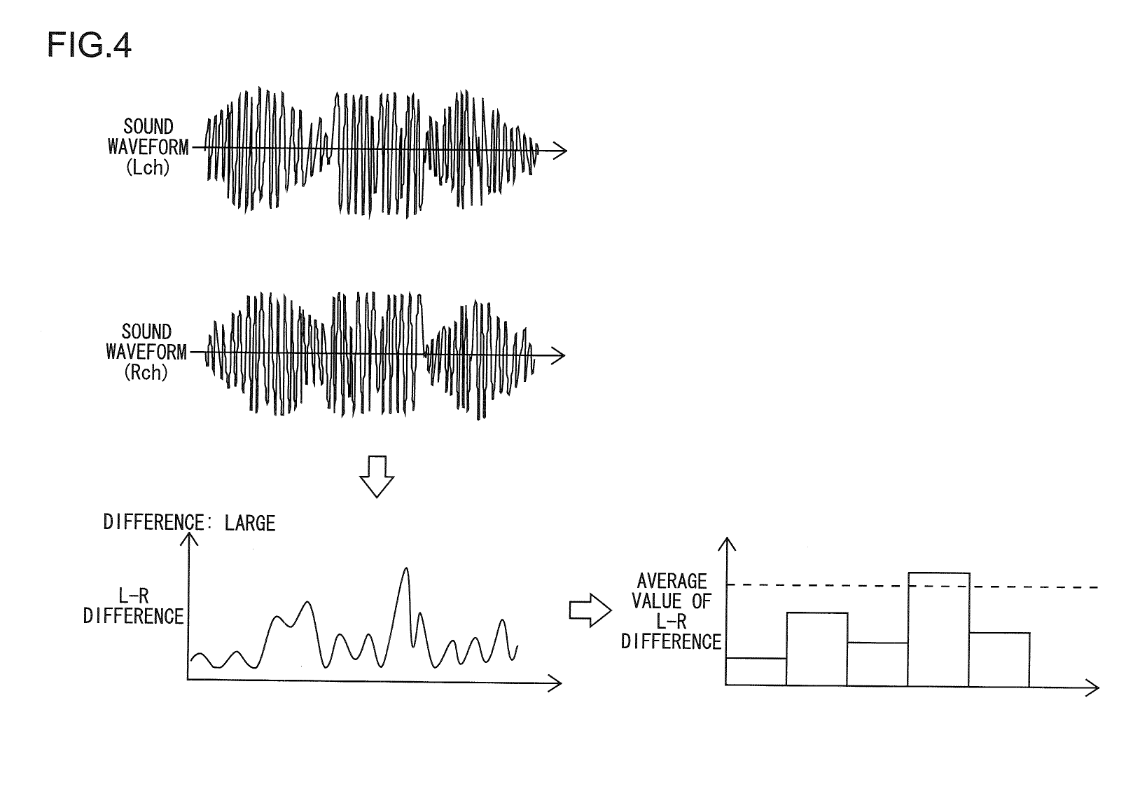

Further, FIG. 4 illustrates a visual concept of the L-R difference. The graph at the left top illustrates a waveform of the left-channel audio signal of a stereo sound. The graph at the left middle illustrates a waveform of the right-channel audio signal. The graph at the left bottom illustrates a waveform of the difference (L-R difference) signal between the two left and right channels of the audio signal. The graph on the right illustrates average values of L-R difference values during fixed times.

If a change point at which the change amount of the audio power is equal to or larger than a predetermined value (indicated by, for example, the broken line of the graph at the left bottom of FIG. 3) is detected (yes in S6), the average value of the audio power (for example, the graph on the right of FIG. 3) and the average value of the L-R difference (the graph on the right of FIG. 4) are calculated during a fixed time before and after the change point (S7 and S8). If the average value of the audio power is equal to or lager than a threshold value (indicated by, for example, the broken line of the graph on the right of FIG. 3), or if the average value of the L-R difference is equal to or lager than a threshold value (indicated by the broken line of the graph at the right middle of FIG. 4) (yes in S9), it is judged that the change point indicates the music track portion, and the procedure returns to Step S6. Then, the same judgment of Steps S7 to S9 is performed on the next change point.

On the other hand, if neither the average value of a power nor the average value of the L-R difference is equal to or lager than the threshold value, a position of the change point (relative time instant with reference to the start of recording) is recorded as a non-music track point (TA(i)) (S10). This procedure is repeated until an instruction to stop the recording is issued (S11, S12).

If the instruction to stop the recording is issued (yes in S12), the encoding is stopped, the non-music track point (TA(i)) is saved, and the recorded file is closed (S13). The non-music track point (TA(i)) may be saved in the recorded file separately from the compressed audio data, or may be saved in a file other than the recorded file.

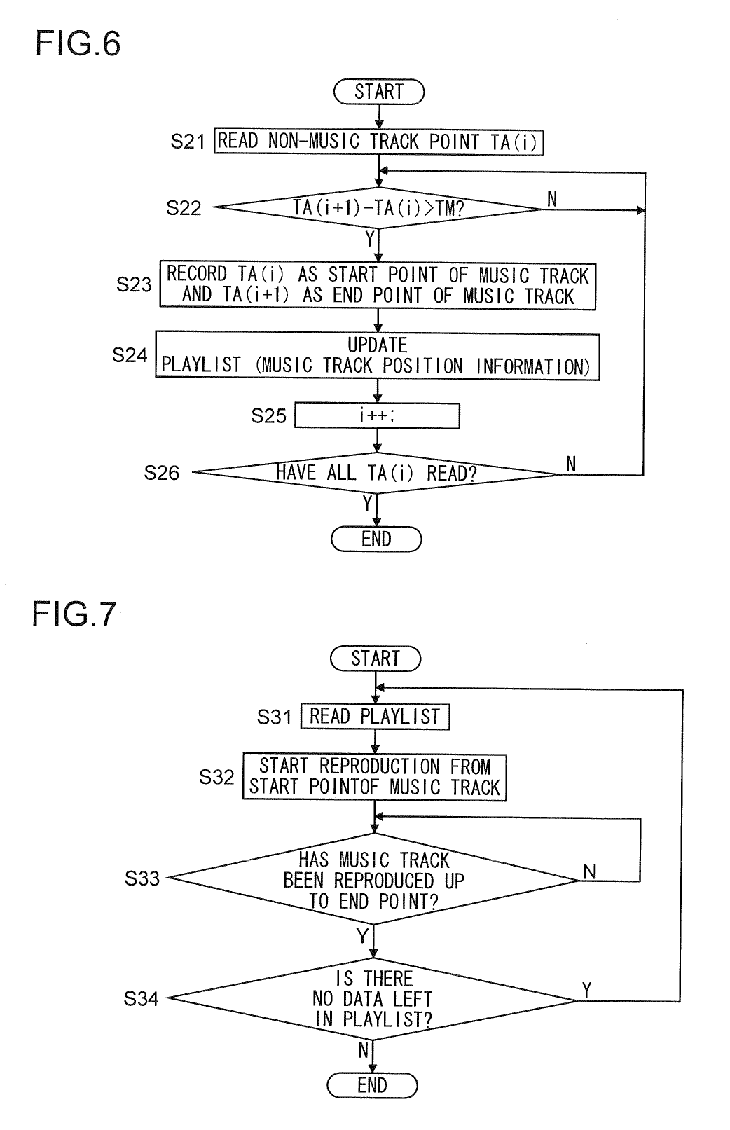

Note that, only the non-music track point is recorded and a music track point is not recorded in the above-mentioned processing because the recording/reproduction device 100 according to this embodiment judges that a segment (1) between the non-music track point and the next non-music track point (2) which has a length equal to or longer than a predetermined time (for example, equal to or longer than 90 seconds) is a music track segment (which is described later with reference to the flowchart of FIG. 6). As a result of an experiment, the present applicant found that much more change points occurred in a non-music track part such as a talk than in a music track part. Therefore, it is practical to regard the segment between the non-music track point and the next non-music track point as the music track segment as described above.

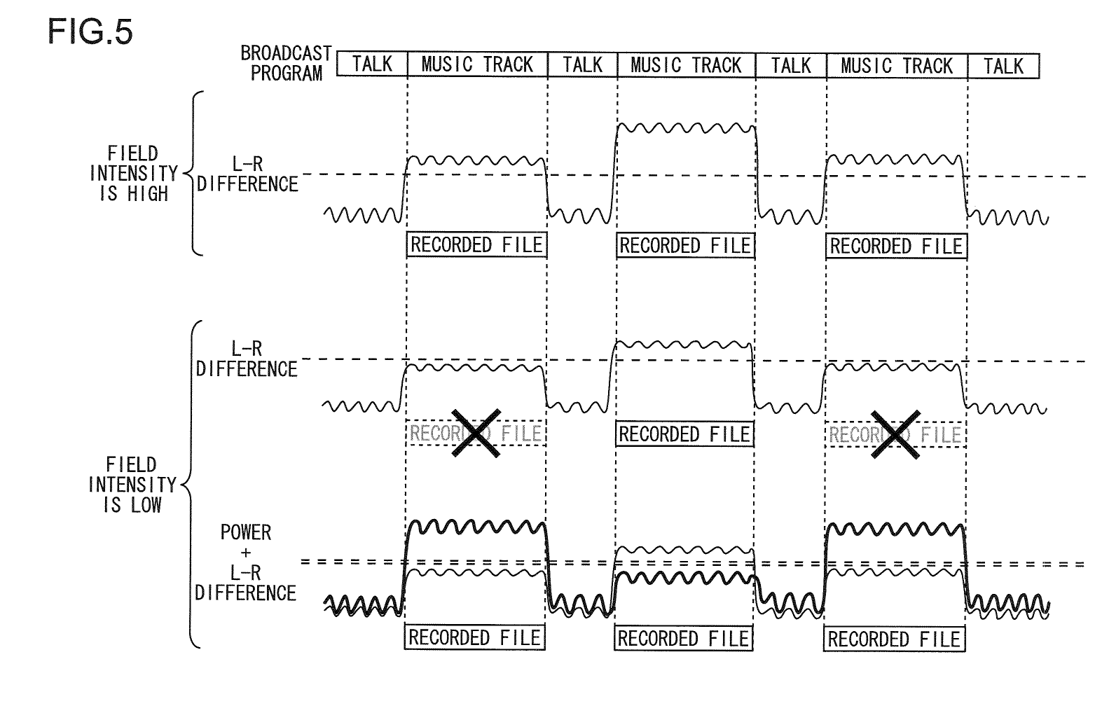

Further, in the above-mentioned processing, the non-music track point is determined if neither the average value of the power nor the average value of the L-R difference is equal to or lager than the threshold value, while the music track point is determined if the average value of the audio power or the average value of the L-R difference is equal to or lager than the threshold value, because: (1) the average value of the audio power tends to be larger in the music track portion than in the non-music track portion; and (2) the average value of the audio power does not become so small even if the field intensity is lowered. This is described with reference to FIG. 5.

The graph at the top of FIG. 5 is a schematic diagram of an L-R difference signal for a case where the field intensity is high. If the field intensity is high, an L-R difference value of the music track portion is large (equal to or larger than the threshold value indicated by the broken line of FIG. 5), and the L-R difference value of a talk portion (non-music track portion) is small (not equal to or lager than the threshold value). Therefore, the music track portion can be correctly extracted.

The graph at the middle of FIG. 5 is a schematic diagram of the L-R difference signal for a case where the field intensity is low. If the field intensity is low, there is a small difference between the L-R difference values of the music track part and the non-music track part. In this example, the L-R difference values of the first and third music track portions are not equal to or lager than the threshold value, and hence the first and third music track portions may be erroneously judged as the non-music track portions.

The graph at the bottom of FIG. 5 is a schematic diagram of the L-R difference signal for the case where the field intensity is low along with a power value superposed thereon. The L-R difference values of the first and third music track portions are small, while the power values of the first and third music track portions are not so small. From this fact, it is clear that the lowering of the field intensity hardly influences the power value. In addition, it is clear that the power value is small in the talk portion. However, the power value is not so large in the second music track portion, and hence a judgment only based on the power value might lead to an erroneous judgment. Accordingly, in the case where the field intensity is low, an extraction accuracy of the music track portion can be improved by using both the L-R difference signal and the power value.

FIG. 6 is a flowchart of playlist (music track position information) generation performed by the recording/reproduction device 100 according to the first embodiment. The playlist is a list indicating which position of the recorded file a music track is recorded in.

First, a non-music track point TA(i) is read from a recorded file or the like (S21). Then, a distance (for example, TA(1)-TA(0)) between adjacent non-music track points TA(i) is calculated (S22). If the distance is equal to or longer than TM seconds (for example, equal to or longer than 90 seconds), the non-music track points TA(0) and TA(1) are recorded as the start point and the end point of the music track, respectively (S23). If the distance is shorter than TM seconds, the procedure returns to Step S22 while incrementing i by 1, in which TA(2)-TA(1) is calculated and compared with TM seconds. This processing is repeated until there is no candidate for point data indicating a music track (until the judgment of Step S26 results in yes).

FIG. 7 is a flowchart of reproduction performed by the recording/reproduction device 100 according to the first embodiment. The time instant of the start point of the first music track recorded in the recorded file is read from the playlist (S31), and reproduction thereof is started at the start point (S32). If the first music track has been reproduced up to the end point (yes in S33), the reproduction is stopped. The time instant of the start point of the second music track is read, and the reproduction is started. This processing is repeated until there is no start point/end point data of the music tracks left in the playlist (no in S34).

### Second Embodiment

First, a recording/reproduction device 100a according to a second embodiment being an embodiment of the present invention is described in detail with reference to the drawings. Note that, the second embodiment is a specific example of performing a judgment between the music track portion and the non-music track portion by using the above-mentioned characteristic found by the present applicant (that more change points occur in the non-music track part such as a talk than in the music track part).

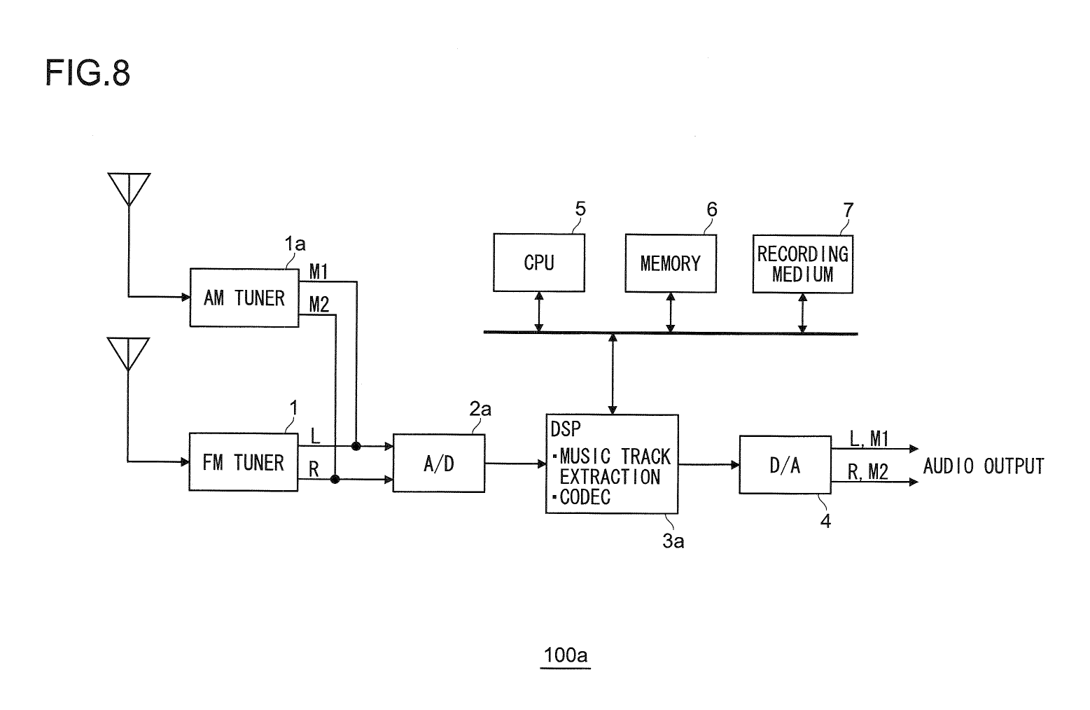

FIG. 8 is a hardware configuration diagram of the recording/reproduction device 100a according to the second embodiment being an embodiment of the present invention. Note that, FIG. 8 corresponds to FIG. 1, which illustrates the recording/reproduction device 100 according to the first embodiment. In FIG. 8, the same components as those of FIG. 1 are denoted by the same reference numerals, and detailed descriptions thereof are omitted.

The recording/reproduction device 100a according to this embodiment includes the FM tuner 1, an AM tuner 1a, the A/D conversion section 2a, a DSP 3a, the D/A conversion section 4, the CPU 5, the memory 6, and the recording medium 7.

The AM tuner 1a demodulates an AM broadcast wave and outputs an analog audio signal. The A/D conversion section 2a converts the analog audio signal output from the FM tuner 1 and the AM tuner 1a into a digital audio signal. The DSP 3a includes the music track extraction section and the audio codec section, but the configuration and operation of the music track extraction section are different from those of the DSP 3 of the recording/reproduction device 100 according to the first embodiment (details thereof is described later). The D/A conversion section 4 converts the digital audio signal into an analog audio signal and outputs the analog audio signal. The CPU 5, the memory 6, and the recording medium 7 are the same as those of the recording/reproduction device 100 according to the first embodiment.

Note that, FIG. 8 illustrates as an example the AM tuner 1a configured to output a monaural signal obtained by demodulation as a signal of two channels M1 and M2, but the AM tuner 1a may be configured to output a monaural signal of one channel. In the same manner, the A/D conversion section 2a and the D/A conversion section 4 may be configured to output a monaural signal of one channel. Further, FIG. 8 illustrates as an example the recording/reproduction device 100a configured to include separate tuners (FM tuner 1 and AM tuner 1a) corresponding to the broadcast waves to be processed and to have the other portions (in particular, A/D conversion section 2a and D/A conversion section 4) shared by the signals from the separate tuners, but it can be arbitrarily changed which component is shared or provided separately. Further, the FM tuner 1 and the AM tuner 1a may be configured to be able to be activated at the same time, or any one thereof may be configured to be able to be activated.

Next, the music track extraction section included in the DSP 3a of the recording/reproduction device 100a according to the second embodiment is described in detail with reference to the drawings.

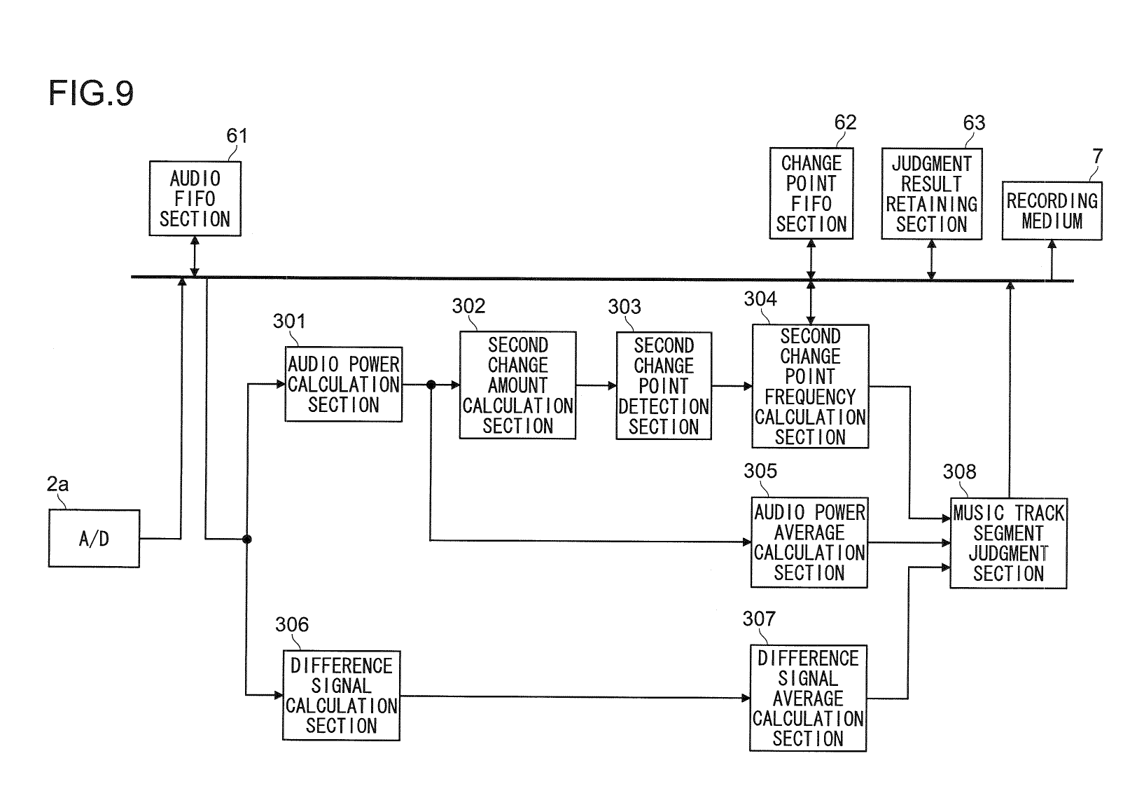

FIG. 9 is a functional block diagram of a main portion of the recording/reproduction device 100a according to the second embodiment. FIG. 9 illustrates portions related to the operation of the music track extraction section of the DSP 3a.

The music track extraction section included in the DSP 3a of the recording/reproduction device 100a according to this embodiment includes an audio power calculation section 301, a second change amount calculation section 302, a second change point detection section 303, a second change point frequency calculation section 304, an audio power average calculation section 305, a difference signal calculation section 306, a difference signal average calculation section 307, and a music track segment judgment section 308.

In the same manner as in the recording/reproduction device 100 according to the first embodiment, as illustrated in FIG. 3, the audio power calculation section 301 calculates the audio power from the audio signal. For example, the audio power can be calculated by raising a signal value of one channel of the audio signal to the second power. Note that, the audio power calculation section 301 may calculate the audio power by using signal values of a plurality of channels of the audio signal. For example, the audio power may be calculated after combining the plurality of channels of the audio signal into one channel by equalization, a known monauralization, or the like. Further, the recording/reproduction device 100 according to the first embodiment may calculate the audio power by the same method.

In the same manner as in the recording/reproduction device 100 according to the first embodiment, as illustrated in FIG. 3, the second change amount calculation section 302 calculates a second change amount (which is expressed as “second change amount” in this embodiment in order to distinguish from the change amount according to the first embodiment; the same applies hereinbelow) of the audio power calculated by the audio power calculation section 301. For example, the second change amount can be calculated as a magnitude (for example, positive value) of a change in the audio power during a first time described later. Note that, the recording/reproduction device 100 according to the first embodiment may calculate the change amount by the same method, but the time for the calculation is not limited to the first time.

In the same manner as in the recording/reproduction device 100 according to the first embodiment, as illustrated in FIG. 3, the second change point detection section 303 detects a second change point (which is expressed as “second change point” in this embodiment in order to distinguish from the change point according to the first embodiment; the same applies hereinbelow) at which the second change amount calculated by the second change amount calculation section 302 is equal to or larger than a second predetermined value (which is expressed as “second predetermined value” in this embodiment in order to distinguish from the predetermined value according to the first embodiment; the same applies hereinbelow).

The second change point frequency calculation section 304 calculates a frequency of the second change point detected by the second change point detection section 303. For example, it is possible to count the number of second change points included in a second time described later and calculate the number as the frequency of the second change point.

In the same manner as in the recording/reproduction device 100 according to the first embodiment, as illustrated in FIG. 3, the audio power average calculation section 305 calculates the average value of the audio power by equalizing the audio power calculated by the audio power calculation section 301 during a predetermined time. For example, the average value of the audio power is calculated by equalizing the audio power during the first time described later. Note that, the recording/reproduction device 100 according to the first embodiment may calculate the average value of the audio power by the same method, but the time for the calculation is not limited to the first time.

In the same manner as in the recording/reproduction device 100 according to the first embodiment, as illustrated in FIG. 4, the difference signal calculation section 306 calculates the difference signal by obtaining a difference (for example, positive value) between signal values of the plurality of channels of the audio signal.

In the same manner as in the recording/reproduction device 100 according to the first embodiment, as illustrated in FIG. 4, the difference signal average calculation section 307 calculates the average value of the difference signal by equalizing the difference signal calculated by the difference signal calculation section 306 during a predetermined time. For example, the average value of the difference signal is calculated by equalizing the difference signal during the first time described later. Note that, the recording/reproduction device 100 according to the first embodiment may calculate the average value of the difference signal by the same method, but the time for the calculation is not limited to the first time.

In the same manner as in the recording/reproduction device 100 according to the first embodiment, the music track segment judgment section 308 performs the judgment between the music track portion and the non-music track portion based on the magnitude of the audio power (the above-mentioned power value) and the magnitude of the difference signal (the above-mentioned difference value). Specifically, if it is confirmed at least one of that the average value of the audio power calculated by the audio power average calculation section 305 is equal to or larger than the threshold value as illustrated in FIGS. 3 and 5 and that the average value of the difference signal calculated by the difference signal average calculation section 307 is equal to or larger than the threshold value as illustrated in FIGS. 4 and 5, the music track segment judgment section 308 judges at least one part of the confirmed time as the music track portion. In contrast, if it is confirmed both of that the average value of the audio power calculated by the audio power average calculation section 305 is smaller than the threshold value as illustrated in FIGS. 3 and 5 and that the average value of the difference signal calculated by the difference signal average calculation section 307 is smaller than the threshold value as illustrated in FIGS. 4 and 5, the music track segment judgment section 308 judges at least one part of the confirmed time as the non-music track portion.

Further, in the recording/reproduction device 100a according to this embodiment, the music track segment judgment section 308 performs the judgment between the music track portion and the non-music track portion based on a frequency at which the change amount of the audio power becomes equal to or larger than a predetermined magnitude. An outline of the above-mentioned judgment method is described in detail with reference to the drawings.

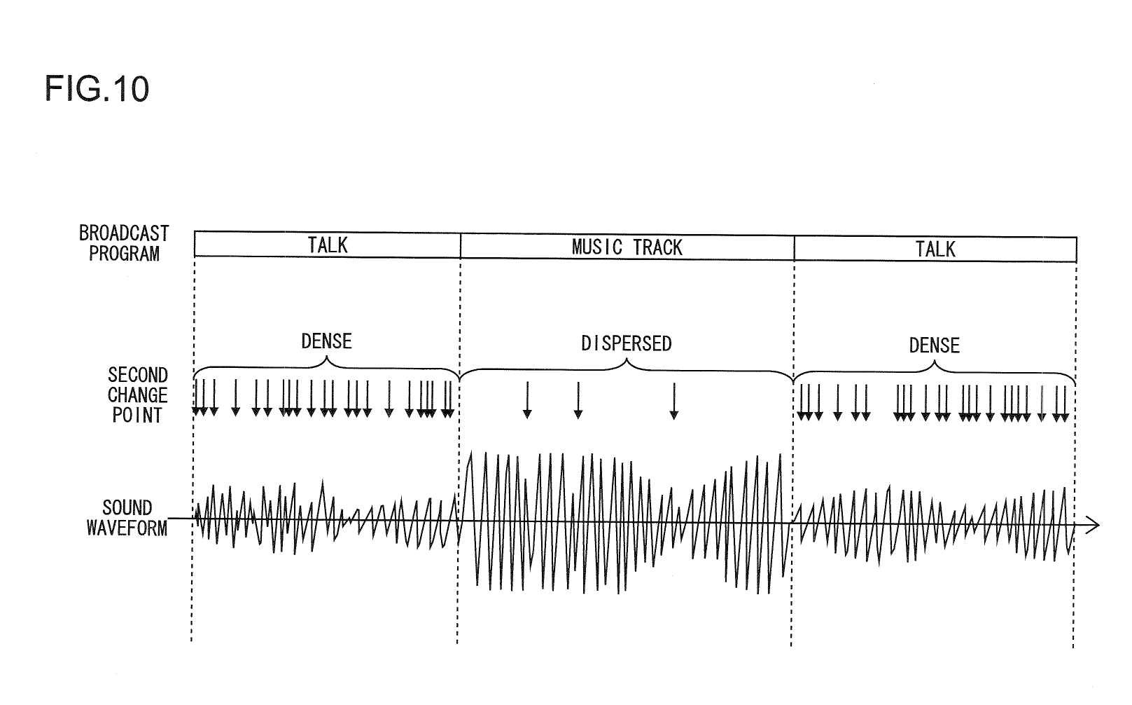

FIG. 10 illustrates a visual concept of the audio signal waveform and the frequency of the second change point. As described above and as illustrated in FIG. 10, a frequency at which the change amount of the audio power becomes equal to or larger than a predetermined magnitude (at which the second change point is detected by the second change point detection section 303) is large (dense) in the non-music track portion (for example, talk portion) and small (dispersed) in the music track portion.

Therefore, if it is confirmed that the frequency of the second change point calculated by the second change point frequency calculation section 304 is equal to or smaller than the threshold value, the music track segment judgment section 308 judges at least one part of the confirmed time as the music track portion. Further, if it is confirmed that the frequency of the second change point calculated by the second change point frequency calculation section 304 is larger than the threshold value, the music track segment judgment section 308 judges at least one part of the confirmed time as the non-music track portion.

That is, if it is confirmed at least one of that the average value of the audio power is equal to or larger than the threshold value, that the average value of the difference signal is equal to or larger than the threshold value, and that the frequency of the second change point is equal to or smaller than the threshold value, the music track segment judgment section 308 judges at least one part of the confirmed time as the music track portion. In contrast, if it is confirmed all of that the average value of the audio power is smaller than the threshold value, that the average value of the difference signal is smaller than the threshold value, and that the frequency of the second change point is larger than the threshold value, the music track segment judgment section 308 judges at least one part of the confirmed time as the non-music track portion.

With the above-mentioned configuration, the judgment between the music track portion and the non-music track portion of the audio signal is performed based on the state of the audio power. Therefore, even if received field intensity is low or even if a broadcast being received is transmitting only the monaural data, it is possible to perform the judgment between the music track portion and the non-music track portion of the audio signal with high accuracy. This is not limited to the recording/reproduction device 100a according to this embodiment, and the same applies to the recording/reproduction device 100 according to the first embodiment.

Note that, in the recording/reproduction device 100a according to this embodiment, the music track segment judgment section 308 performs the judgment between the music track portion and the non-music track portion of the audio signal based on three factors, that is, the magnitude of the audio power, the magnitude of the difference signal, and the frequency at which the change amount of the audio power becomes large, but the judgment based on at least one of the magnitude of the audio power and the magnitude of the difference signal does not need to be performed. That is, the recording/reproduction device 100a may be configured to exclude at least one of the audio power average calculation section 305 and the pair of the difference signal calculation section 306 and the difference signal average calculation section 307. Further, the same applies to the recording/reproduction device 100 according to the first embodiment, and the judgment based on the magnitude of the difference signal does not need to be performed.

However, it is preferred that the judgment between the music track portion and the non-music track portion of the audio signal be performed by using various kinds of judgment methods because the judgment can be performed with high accuracy as described in the first embodiment. Further, as described above, if a portion to be judged as the music track portion is judged as the music track portion by any one of a plurality of judgment methods, the music track portions of the audio signal can be judged without exception.

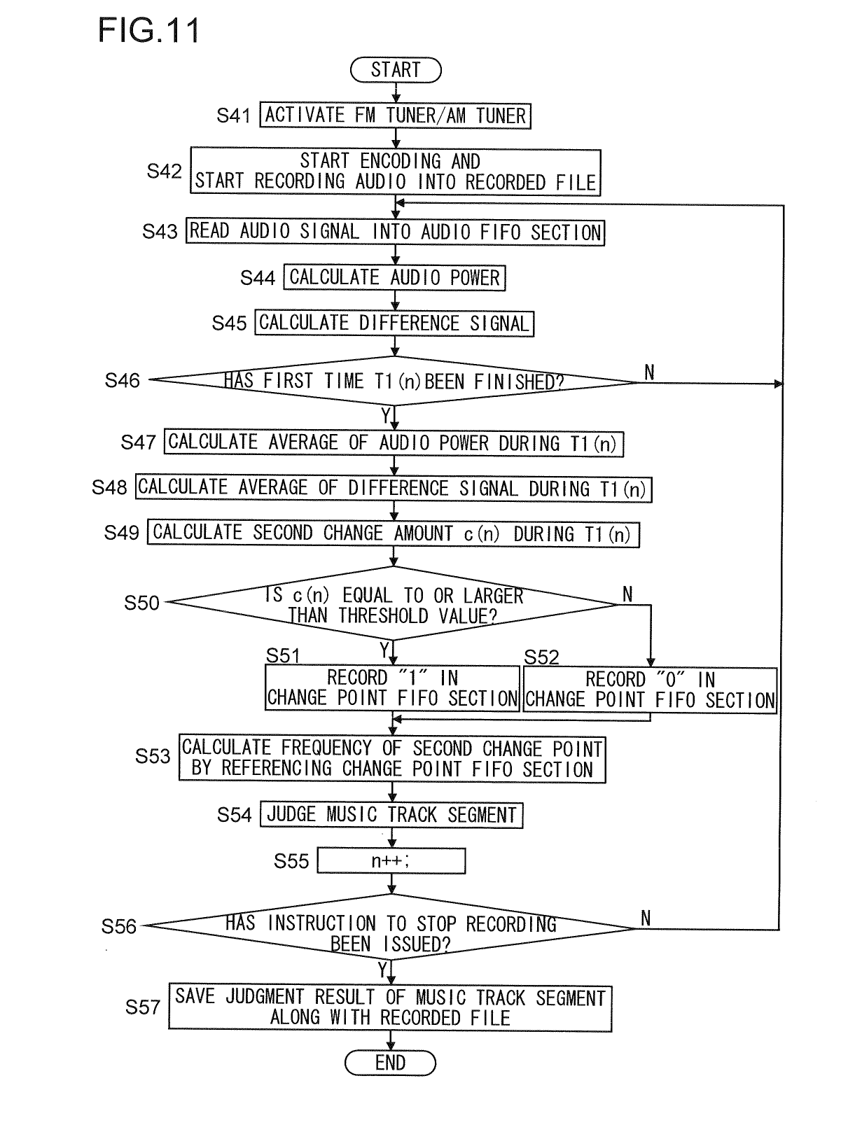

Next, a specific example of the operation of the recording/reproduction device 100a according to the second embodiment illustrated in FIGS. 8 and 9 is described in detail with reference to the drawings. FIG. 11 is a flowchart of a recording processing performed by the recording/reproduction device 100a according to the second embodiment. Further, FIG. 11 corresponds to FIG. 2 which is the flowchart of the recording processing performed by the recording/reproduction device 100 according to the first embodiment.

As illustrated in FIG. 11, the recording/reproduction device 100a according to this embodiment first activates at least one of the FM tuner 1 and the AM tuner 1a, and starts to acquire the audio signal (S41). Further, the encoder within the DSP 3a is activated, and the encoding of the audio signal to be recorded in the recorded file on the recording medium 7 is started (S42). Further, a variable n for identifying a timing at which the judgment is performed (first time and second time that are described later) is initialized (for example, set to 1). The variable n is managed by, for example, the CPU 5, the DSP 3a, and the like.

Subsequently, the audio signals output from the A/D conversion section 2a are sequentially read into an audio first-in first-out (FIFO) section 61 (S43). Then, the music track extraction section of the DSP 3a performs the above-mentioned judgment on the audio signals sequentially read from the audio FIFO section 61. Note that, the audio FIFO section 61 can be interpreted as a part of the memory 6.

First, the audio power calculation section 301 calculates the audio power as described above (S44). Further, the difference signal calculation section 306 calculates the difference signal as described above (S45). The calculation of the audio power and the calculation of the difference signal are performed until the processing on the audio signal during a first time T1(n) is finished (until the judgment of Step S46 results in yes).

The first time T1(n) is a unit time for performing a processing (judgment) by dividing the audio signal by predetermined times. One first time has a duration of, for example, several tens of milliseconds (ms).

After the audio power and the difference signal of the audio signal during the first time T1(n) are calculated, the audio power average calculation section 305 calculates the average value of the audio power during the first time T1(n) as described above (S47). Further, the difference signal average calculation section 307 calculates the average value of the difference signal during the first time T1(n) as described above (S48). Further, the second change amount calculation section 302 calculates a second change amount c(n) of the audio power during the first time T1(n) as described above (S49).

If the second change amount c(n) is equal to or larger than the threshold value (yes in S50), a data item “1” indicating that the second change point exists is recorded in a change point FIFO section 62 (S51). On the other hand, if the second change amount c(n) is smaller than the threshold value (no in S50), a data item “0” indicating that the second change point does not exist is recorded in the change point FIFO section 62 (S52). Note that, the change point FIFO section 62 can be interpreted as a part of the memory 6.

Further, the second change point frequency calculation section 304 calculates the frequency of the second change point by referencing the data items recorded in the change point FIFO section 62 (S53). At this time, at least the data items regarding the second change point detected from a music signal during a second time T2(n) are recorded in the change point FIFO section 62. The second change point frequency calculation section 304 calculates the frequency of the second change point by counting the number of the data items “1” indicating that the second change point exists among the data items during the second time T2(n) read from the change point FIFO section 62 (S53).

In the same manner as the first time T1(n), the second time T2(n) is a unit time for performing a processing (judgment) by dividing the audio signal by predetermined times. One second time T2(n) has a duration of, for example, several seconds (s). Note that, the second time T2(n) is a time for calculating the frequency of the second change point, and hence it is preferred that the second time T2(n) be at least a time longer than the first time T1(n).

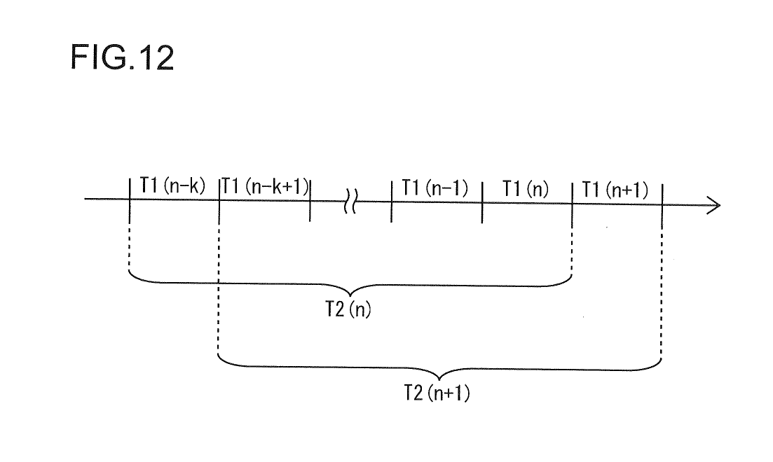

The first time T1(n) and the second time T2(n) are described in detail with reference to the drawings. FIG. 12 illustrates a visual concept of the first time and the second time. As illustrated in FIG. 12, the second time T2(n) includes k+1 first times T1(n-k) to T1(n) (where k is a natural number). Further, in Steps S50 to S52, the data items are sequentially recorded (updated) in the change point FIFO section 62, and hence a second time T2(n+1) subsequent to the second time T2(n) is shifted by one first time. That is, the second time T2(n+1) includes k+1 first times T1(n−k+1) to T1(n+1).

Further, as described above, the music track segment judgment section 308 performs the judgment between the music track portion and the non-music track portion of the audio signal based on the three factors, that is, the magnitude of the audio power, the magnitude of the difference signal, and the frequency at which the change amount of the audio power becomes large (S54). Note that, the music track segment judgment section 308 may output the non-music track point TA(i) as a judgment result in the same manner as in the recording/reproduction device 100 according to the first embodiment.

The time of the audio signal at which the music track segment judgment section 308 performs the judgment based on the magnitude of the audio power and the magnitude of the difference signal is at least a part of the first time T1(n) (for example, time instant substantially at the midpoint of the first time T1(n)). Meanwhile, the time at which the judgment is performed based on the frequency at which the change amount of the audio power becomes large is at least a part of the second time T2(n) (for example, time instant substantially at the midpoint of the second time T2(n)).

As described above, in the recording/reproduction device 100a according to this embodiment, the time of the audio signal at which the music track segment judgment section 308 performs the judgment may be shifted depending on each judgment method. Therefore, for example, judgment results obtained sequentially (for example, respective judgment results based on the magnitude of the audio power and the magnitude of the difference signal) may be retained in a judgment result retaining section 63, and final judgment results may be output after the judgment results obtained by the above-mentioned three methods have been produced. Note that, the judgment result retaining section 63 can be interpreted as a part of the memory 6.

If the judgment is performed on the audio signal in Step S54, for example, the CPU 5, the DSP 3a, or the like increments the variable n by 1 (S55). Then, the above-mentioned judgment (S43 to S55) is repeated until the instruction to stop the recording is issued (until the judgment of S56 results in yes).

If the instruction to stop the recording is issued (yes in S56), the encoding is stopped, the judgment results (for example, non-music track point TA(i)) are saved, and the recorded file is closed (S57). The judgment results may be saved in the recorded file separately from the compressed audio data, or may be saved in a file other than the recorded file.

With such a configuration, it is possible to smoothly combine and perform the respective judgment methods based on the magnitude of the audio power, the magnitude of the difference signal, and the frequency at which the change amount of the audio power becomes large.

Note that, there may be a case where sufficient data (data on the second time T2(n) necessary for the judgment) is not recorded in the change point FIFO section 62 at the start or the end of the judgment. In such a case, for example, the judgment result of other judgment methods (judgments based on the magnitude of the audio power and the magnitude of the difference signal) may be employed, the judgment may be performed by referencing data during a time shorter than the second time T2(n) recorded in the change point FIFO section 62, or the judgment may be performed by compensating insufficient data by dummy data.

Further, the judgment result produced by a judgment method having a high judgment accuracy may be given a higher priority than the judgment result produced by another judgment method. In this case, for example, the final judgment may be performed by assigning priorities to (weighting) the judgment results produced by the respective judgment methods and combining the judgment results produced by the respective judgment methods.

Further, in the case where the music track segment judgment section 308 outputs the non-music track point TA(i) as the judgment result, the method of generating the playlist as illustrated in FIG. 6 and the method of reproducing the playlist as illustrated in FIG. 7 according to the recording/reproduction device 100 according to the first embodiment can also be applied to the recording/reproduction device 100a according to this embodiment.

### Another Example of the Second Embodiment

The same judgment methods as those in the recording/reproduction device 100 according to the first embodiment may be employed in the respective judgments based on the magnitude of the audio power and the magnitude of the difference signal performed by the music track segment judgment section 308 of the recording/reproduction device 100a according to the second embodiment. The configuration for this case is described in detail with reference to the drawings.

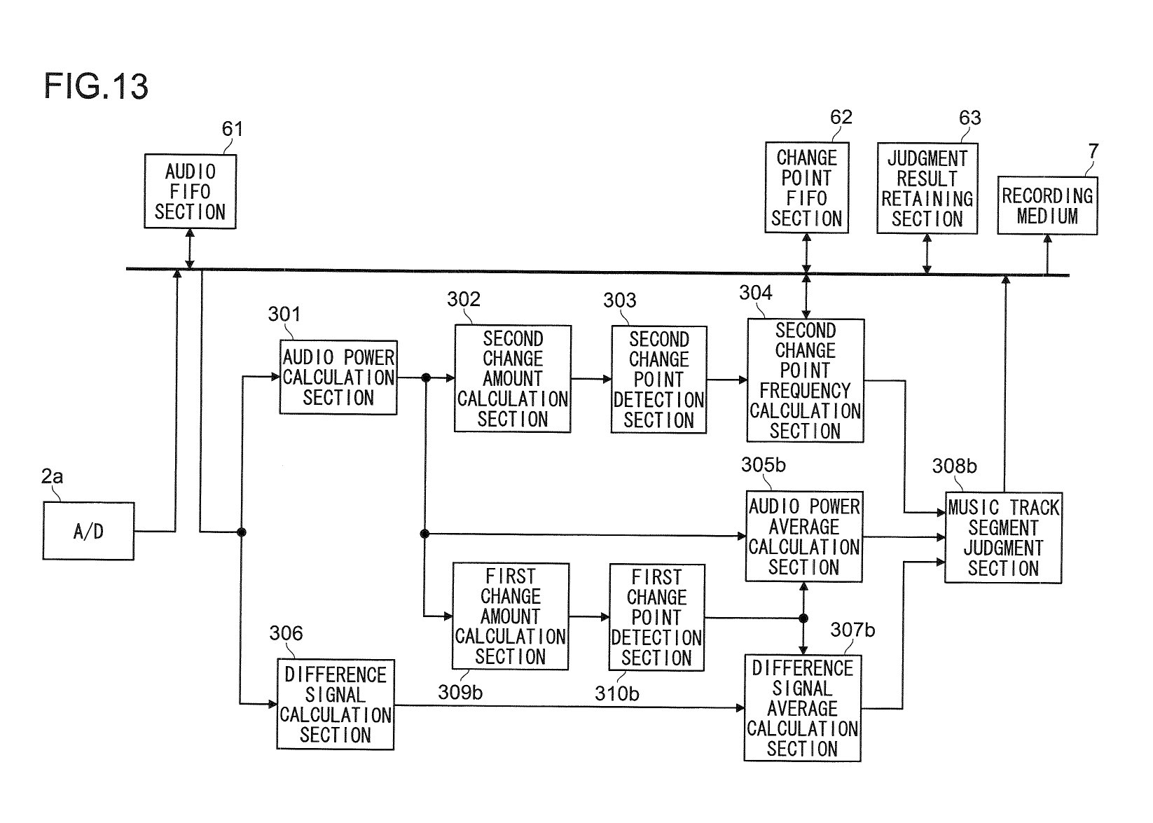

FIG. 13 is a functional block diagram of a main portion of the recording/reproduction device 100a according to another example of the second embodiment. Note that, FIG. 13 corresponds to FIG. 9 which illustrates the normally used recording/reproduction device 100a according to the second embodiment, and in FIG. 13, the same components as those of FIG. 9 are denoted by the same reference numerals, and detailed descriptions thereof are omitted.

The music track extraction section included in the DSP 3a of the recording/reproduction device 100a according to this example includes the audio power calculation section 301, the second change amount calculation section 302, the second change point detection section 303, the second change point frequency calculation section 304, an audio power average calculation section 305b, the difference signal calculation section 306, a difference signal average calculation section 307b, a music track segment judgment section 308b, a first change amount calculation section 309b, and a first change point detection section 310b.

As illustrated in FIG. 3, the first change amount calculation section 309b calculates the same change amount as that of the recording/reproduction device 100 according to the first embodiment (hereinafter, referred to as “first change amount”). Further, as illustrated in FIG. 3, the first change point detection section 310b calculates the same change point as that of the recording/reproduction device 100 according to the first embodiment (hereinafter, referred to as “first change point”).

Then, in the same manner as in the recording/reproduction device 100 according to the first embodiment, as illustrated in FIG. 3, the audio power average calculation section 305b calculates the average value of the audio power during a fixed time before and after the first change point detected by the first change point detection section 310b.

Further, in the same manner as in the recording/reproduction device 100 according to the first embodiment, as illustrated in FIG. 4, the difference signal average calculation section 307b calculates the average value of the difference signal during the fixed time before and after the first change point detected by the first change point detection section 310b.

In the same manner as in the recording/reproduction device 100 according to the first embodiment, the music track segment judgment section 308b performs the judgment at the time instant of the first change point of the audio signal based on the magnitude of the audio power and the magnitude of the difference signal. Further, in the same manner as in the normally used recording/reproduction device 100a according to the second embodiment, the music track segment judgment section 308b performs the judgment at a time of at least one part of the second time T2(n) (for example, time instant substantially at the midpoint of the second time T2(n)) based on a frequency at which the second change amount of the audio power becomes large (the number of the second change points included in the second time T2(n)).

Even with such a configuration, it is possible to combine and perform the respective judgment methods based on the magnitude of the audio power, the magnitude of the difference signal, and the frequency at which the change amount of the audio power becomes large.

Note that, the second predetermined value used by the second change point detection section 303 which detects the second change point may be set smaller than the predetermined value used by the first change point detection section 310b which detects the first change point as illustrated in FIG. 3 (hereinafter, referred to as “first predetermined value”).

With such a configuration, the first change point and the second change point that are suitable for each of the judgment methods can be detected, which can improve the judgment accuracy of each of the judgment methods. Specifically, for example, the judgment accuracy of the judgment methods based on the magnitude of the audio power and the magnitude of the difference signal can be improved if the first predetermined value is raised to an extent that allows a boundary between the music track portion and the non-music track portion to be judged with high certainty. Further, for example, the judgment accuracy of the judgment method based on the frequency at which the change amount of the audio power becomes large can be improved if the second predetermined value is reduced to an extent that allows a dispersed state and a dense state to be clearly distinguished from each other (that increases a difference between the numbers of the second change points in the respective states).

Further, in this example, the second change amount calculation section 302 and the first change amount calculation section 309b may be shared. Further, the second change point detection section 303 and the first change point detection section 310b may be shared. With such a configuration, a processing amount of the DSP 3a can be reduced.

### Modified Example

A part or all of the operations of the DSPs 3 and 3a or the like of the recording/reproduction devices 100 and 100a according to the embodiments of the present invention may be performed by a control device such as a microcomputer. Further, all or a part of functions realized by such a control device may be described as a program, and all or a part of functions realized by such a control device may be realized by executing the program on a program execution device (for example, computer).

Further, irrespective of the above-mentioned case, the recording/reproduction devices 100 and 100a illustrated in FIGS. 1, 8, 9, and 13 can be realized by hardware or a combination of hardware and software. Further, in the case of using software to configure a part of the recording/reproduction devices 100 and 100a, a block regarding a portion realized by the software represents a functional block regarding the portion.

The above-mentioned descriptions of the respective embodiments are intended solely to describe the present invention, and should not be interpreted as limiting the invention beyond the scope of the appended claims or reducing the scope. Further, the respective components of the present invention are not limited to the above-mentioned embodiments, and naturally various kinds of modifications can be made within the technical scope described within the scope of the appended claims.

What is claimed is:

1. A music track extraction device, comprising:
an audio power calculation section which calculates an audio power from an audio signal; and
a judgment section which performs a judgment between a music track portion and a non-music track portion based on a state of the audio power.

2. A music track extraction device according to claim 1, further comprising a difference signal calculation section which calculates a difference signal between a plurality of channels of the audio signal,
wherein the judgment section performs the judgment between the music track portion and the non-music track portion based on the audio power and the difference signal.

3. A music track extraction device according to claim 2, wherein:
the judgment section performs the judgment as a music track if at least one of magnitudes of the difference signal and the audio power is equal to or larger than a corresponding threshold value; and
the judgment section performs the judgment as a non-music track if both the magnitudes of the difference signal and the audio power are smaller than the corresponding threshold values.

4. A music track extraction device according to claim 2, further comprising a first change amount calculation section which calculates a change amount of the audio power,
wherein the judgment section performs the judgment based on the audio power and the difference signal before and after a first change point at which the change amount calculated by the first change amount calculation section becomes equal to or larger than a first predetermined value.

5. A music track extraction device according to claim 4, wherein the judgment section judges, as a music track segment, a segment of the audio signal which has an interval between the first change points judged as a non-music track equal to or longer than a predetermined time.

6. A music track extraction device according to claim 1, further comprising a second change amount calculation section which calculates a change amount of the audio power,
wherein the judgment section performs the judgment based on a frequency at which the change amount calculated by the second change amount calculation section becomes equal to or larger than a second predetermined value.

7. A music track extraction device according to claim 1, further comprising:
a second change amount calculation section which calculates a change amount of the audio power; and
a difference signal calculation section which calculates a difference signal between a plurality of channels of the audio signal,
wherein the judgment section performs the judgment based on:
a magnitude of the audio power during a first time;
a magnitude of the difference signal during the first time; and
a frequency at which the change amount calculated by the second change amount calculation section becomes equal to or larger than a second predetermined value during a second time.

8. A music track extraction device according to claim 7, wherein:
the judgment section judges at least one part of the first time as a music track if at least one of the magnitudes of the difference signal and the audio power during the first time is equal to or larger than a corresponding threshold value; and
the judgment section judges the at least one part of the first time as a non-music track if both the magnitudes of the difference signal and the audio power during the first time are smaller than the corresponding threshold values.

9. A music track extraction device according to claim 6, wherein:
the judgment section counts a number of second change points at which the change amount calculated by the second change amount calculation section becomes equal to or larger than the second predetermined value;
the judgment section judges at least one part of a second time as a music track when the number of the second change points during the second time is equal to or smaller than a threshold value; and
the judgment section judges the at least one part of the second time as a non-music track when the number of the second change points during the second time is larger than the threshold value.

10. A music track extraction device according to claim 9, wherein the judgment section performs the judgment at a time instant substantially at a midpoint of the second time by counting the number of the second change points during the second time.

11. A music track recording device, comprising:
the music track extraction device according to claim 1; and
a recording section which records an audio signal within a segment judged as a music track by the music track extraction device.
